(19) United States
(12) Patent Application Publication
(10) Pub. No.: US 2014/0012603 A1
(43) Pub. Date: Jan. 9, 2014

(54) CAPACITY PLANNING AND MODELING FOR OPTIMIZATION OF TASK OUTCOMES

(71) Applicants: James Scanlon, Tariffville, CT (US); Premnath Ayyalasomayajula, Issaquah, WA (US); Xiaowei Zhu, Avon, CT (US)

(72) Inventors: James Scanlon, Tariffville, CT (US); Premnath Ayyalasomayajula, Issaquah, WA (US); Xiaowei Zhu, Avon, CT (US)

(21) Appl. No.: 13/544,408

(22) Filed: Jul. 9, 2012

(51) Int. Cl. G06Q 10/06; G06Q 40/08

(52) U.S. Cl. 705/4; 705/7.23

(57) ABSTRACT

Systems and methods for optimizing outcomes in view of various business scenarios are based on a unique quantification of work and estimate of task duration, which may be used to develop a measure of the work required to complete a task. This measure may be compared to forecasted work and used to allocate resources accordingly. Additionally, optimal outcomes may be identified subject to any classification, such as by class of worker, type of task, location of task, and/or size of work unit.

### FIELD OF THE INVENTION

The present invention generally relates to systems and methods for determining workload and capacity among various individuals and work units in an organization. More particularly, the present invention relates to systems and methods for accurately determining the amount and type of work being performed by individuals or work units; using this determination to project optimal outcomes of various business solutions; and comparing the projected optimal outcomes to actual, observed outcomes for the various business solutions, in order to determine the most efficient and effective allocation of resources for achieving desired outcomes in the future.

### BACKGROUND

Traditionally, stochastic optimization models for capacity planning in service industries operate by incorporating uncertainties into estimates of future demand, in order to enable resource levels to be planned accordingly. Such optimization models can generate one or more recommended expressions of capacity based on different business scenarios. These capacity expressions enable businesses in such industries to determine projected revenues and/or expenses under each of the different scenarios for which a capacity expression is generated. Each of these scenarios may be weighted by its respective probability of occurrence, in order to identify an optimal solution.

Many existing optimization models operate on the assumption that each of the workers or work units (for example, a field office, a “virtual office” consisting of workers in one or more physical locations, a team of workers working on a set of tasks, or other like grouping) is fungible, i.e., as if each of the workers or work units is capable of producing the same result when working on the same task. In reality, however, each individual worker is unique and operates in a different manner, and at a different level of productivity, from every other individual worker. Likewise, each work unit is also unique, and operates differently from every other work unit. Moreover, many existing models also fail to differentiate between the various types of activities performed by workers or work units, and fail to properly reflect or account for productivity associated with collaboration between workers or work units on particular tasks. Rather, existing models typically assess workload by focusing on particular points in time, and determining the number of tasks remaining open on those particular points in time as a measure of productivity. In one example, where ten workers in an office are handling 1,000 tasks, such as insurance claims, for example, many existing models simply express the office's workload by determining the average number of claims handled by each worker, i.e., 100 claims per worker, and comparing the average calculated at one particular time to the averages calculated at other points in time.

Because existing optimization models fail to accurately reflect or account for the amount of work actually performed by a worker or work unit and merely depict the status of jobs performed by a worker or work unit, such models are unable to differentiate between types of work performed or the individual statuses of respective tasks, and are less effective at projecting future demands or in deriving optimal solutions to various business solutions.

### SUMMARY OF EXEMPLARY EMBODIMENTS

Embodiments of the invention relate to improved systems and methods for accurately determining the level of work performed by individuals and work units, with respect to the type or location of respective tasks to be performed, and using this information to project optimal outcomes of various business solutions. According to some embodiments, the systems and methods include models that customize the estimation of work time based on the type of work performed, the type of assignment, and the worker's location. Embodiments of the invention may have applicability in the insurance industry, where various data is analyzed in an attempt to optimize task (e.g., insurance claim) outcomes. Such data may include, for example, forecasts of claim volumes, determinations of available resources for handling claims, and projections of worker productivity with respect to claims of varying types and work performed in various locations. Although particular features of the invention may be described with reference to embodiments relating to insurance applications, it should be understood that such features are not limited to usage in the one or more particular embodiments or drawings with reference to which they are described, unless expressly specified otherwise.

According to some embodiments, a method for quantifying work may provide accurate estimates of work-time that may be classified or sub-classified on any basis, such as by type of insurance claim, by field office, by class of workers handling claims, or by individual worker (e.g., claim handler). The work-time estimates may be effectively employed to diagnose field claim operation according to the one or more classifications or sub-classifications.

According to other embodiments, claim durations (e.g., throughputs) may be estimated using estimating tools known as “throughput triangulars,” discussed herein with reference to FIGS. 5A-5C. As discussed in detail herein, the throughput triangulars are generated by reviewing claim notices received in a fixed, selected period and determining the specific intervals when each of the claim notices is closed after it is received. The rates at which claims are closed are then transposed forward in order to project when claim notices received in the future will be closed, and backward to estimate when claim notices received in the past will be closed in the future.

According to some embodiments, an operational performance metric for tracking the amount of work required to close a claim is calculated and used to compare operational efficiency subject to one or more classifications or sub-classifications. The length of time required to close a claim represents the efficiency of a worker or work unit at handling claims from notice to closure, and may be determined based on the type of claims, the class of worker, the location of the work unit or claim occurrence, or any other classification or basis.

According to still other embodiments, an optimization model considers the forecasts of claim notice volume and resource pool against the work required to close claims and projects required resource levels for various business scenarios. The optimization models may be utilized to develop a capacity plan, which may include specific levels of staffing with respect to work units, workers, or offices (either actual or virtual), and to estimate the impact of various changes to staffing levels or work unit operations with respect to optimal business outcomes.

According to other embodiments, information regarding actual claim outcomes may be returned to the optimization model in the form of feedback, to improve the efficacy of future capacity plans with respect to optimal business outcomes. The feedback acts as a check on the optimization model, and compares the actual claim outcomes in view of one or more criteria, such as financial criteria, quality criteria, customer satisfaction criteria, regulatory or government criteria, branding criteria, and reputation criteria, to the optimal outcomes projected by the optimization model.

These and other advantages of systems and methods of the present invention will be apparent to those of skill in the pertinent art in view of the drawings, the claims, and the following disclosure.

### BRIEF DESCRIPTION OF THE DRAWINGS

Various objects, features, and advantages of the present invention can be more fully appreciated with reference to the following detailed description, when considered in connection with the following drawings.

FIG. 1 is a block diagram of the components of a system for planning and modeling workload and capacity, in accordance with an embodiment of the present invention.

FIG. 2 is a diagram of the flow of information between the components of a system for planning and modeling workload and capacity, in accordance with an embodiment of the present invention.

FIG. 3 is a block diagram representing a claim balance over time.

FIG. 4 is a flow chart of a process for planning and modeling workload and capacity, according to one embodiment of the present invention.

FIGS. 5A, 5B, and 5C represent claim and notice data for demonstrating projections of claim closure, according to one embodiment of the present invention.

FIG. 6 is a three-dimensional surface plot of outcomes, according to one embodiment of the present invention.

### DETAILED DESCRIPTION

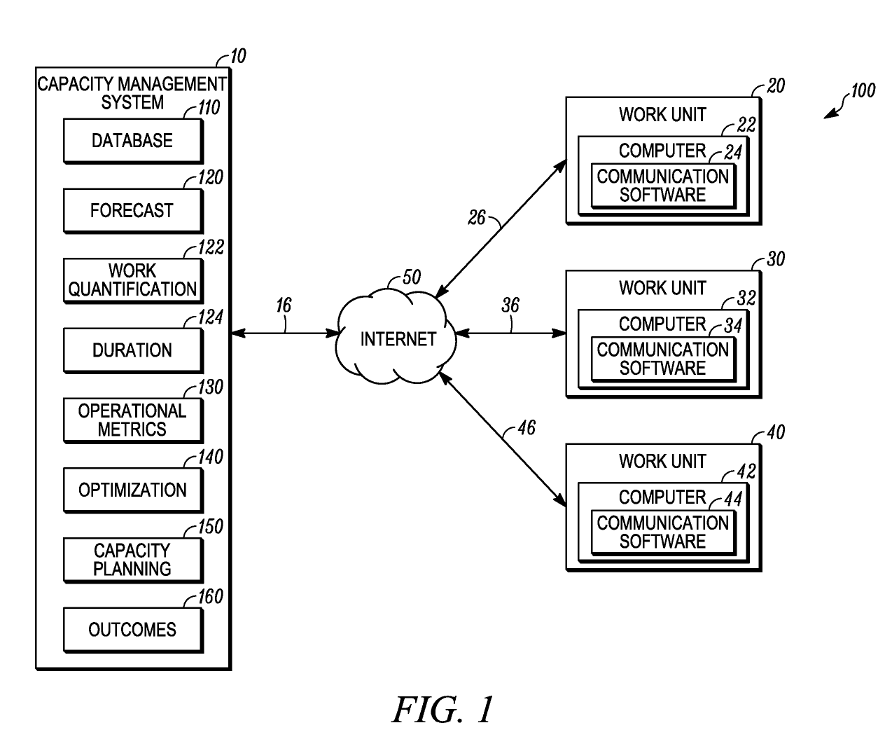

As is set forth above, the present disclosure is directed to systems and methods for determining workload and capacity among various individuals and work units in an organization, in order to optimize one or more task outcomes. Referring to FIG. 1, a system 100 for planning and modeling workload and capacity is shown. The system 100 includes a capacity management system 10 and a plurality of work units 20, 30, 40 connected to a network 50, such as the Internet, for example.

The capacity management system 10 may comprise one or more networked system hardware components connected to a network 50, such as the Internet, and may include one or more computer servers and/or interfaces for operating or practicing one or more systems and methods of the present invention. As is shown in FIG. 1, the capacity management system 10 may include one or more associated components (e.g., modules), including a database 110, a forecasting module 120, a work quantification module 122, a duration module 124, an optimization modeling module 140, a capacity planning module 150, and a set of outcomes 160. Alternatively, the capacity management system 10 may be a software program or application operated on one or more computers or servers.

The database 110 may be utilized to store data of any kind, which may be accessed or utilized by one or more of the other components 120, 122, 124, 140, 150, 160 or work units 20, 30, 40. The forecasting module 120, work quantification module 122, duration module 124, and operational metrics module 130 may be utilized to forecast or quantify business activities based at least in part on data stored in the database 110.

The optimization modeling module 140 may used to determine optimal outcomes for various business solutions. The capacity planning module 150 may be utilized to determine business capacity of any kind with respect to various business solutions. The set of outcomes 160 may include past outcomes for various business activities, including, but not limited to, the types of activities forecasted or quantified by the modules 120, 122, 124, 130.

The work units 20, 30, 40 may comprise sets of one or more workers. The work units 20, 30, 40 may comprise, for example, a field office, a “virtual office,” a team of workers working on a set of tasks, a collection of workers designated or qualified to perform one or more tasks, or other like grouping. The work units 20, 30, 40 may utilize one or more computers 22, 32, 42, which may be adapted to operate one or more communications software applications 24, 34, 44. The computers 22, 32, 42 may be connected to the Internet 50 or other network, as shown by lines 26, 36, 46, by any standard means, such as wired or wireless means.

The hardware components, including various systems and modules, described herein have sufficient electronics, software, memory, storage, databases, firmware, logic/state machines, microprocessors, interfaces, peripherals, and any other necessary devices for performing one or more of the functions described herein and for achieving one or more of the results described herein. One of ordinary skill in the art will understand that the one or more workers in the work unit 20, 30, 40, for example, may operate keyboards or other like devices for interacting with computers 22, 32, 42 or for operating communications software 24, 34, 44 in accordance with the present invention.

Therefore, where a process step disclosed herein is to be performed by a capacity management system 10 or one of its modules 110, 120, 122, 124, 140, 150, 160 or one or more of the work units 20, 30, 40, the process may comprise automated steps that are performed by computer systems or implemented within software programs or applications executed by one or more computers. Where a process step is described as being performed by a system or a work unit 20, 30, 40, such steps may be performed by human operators or by automated agents (e.g., computer systems).

The communication software 24, 34, 44 running on the computers 22, 32, 42 operated by the work units 20, 30, 40 may be any Internet-ready software or application, such as an electronic mail (E-mail) client or any other client-server applications for communicating with the Internet 50, with the capacity management system 10, or with one another. In addition, the computers 22, 32, 42 may be any known computing devices that are capable of communicating over a network, including but not limited to desktops, laptops, “smart” phones, tablets, and the like. The communications protocols for communicating between the computers 20, 30, 40 and the capacity management system 10 are well known to those of ordinary skill in the art.

Data, software, applications, programs, and instructions disclosed herein may be stored on media that may be accessed or read by the computers 22, 32, 42 or the capacity management system 10, and may, when executed by a processing unit (e.g., a computer processor), cause the processing unit to perform one or more of the processes disclosed herein. Such data, software, applications, programs, and instructions and the like may be loaded into the memory of the computers 22, 32, 42 or the system 10 using peripherals that may be associated with the media, such as disk drives or interfaces of any kind.

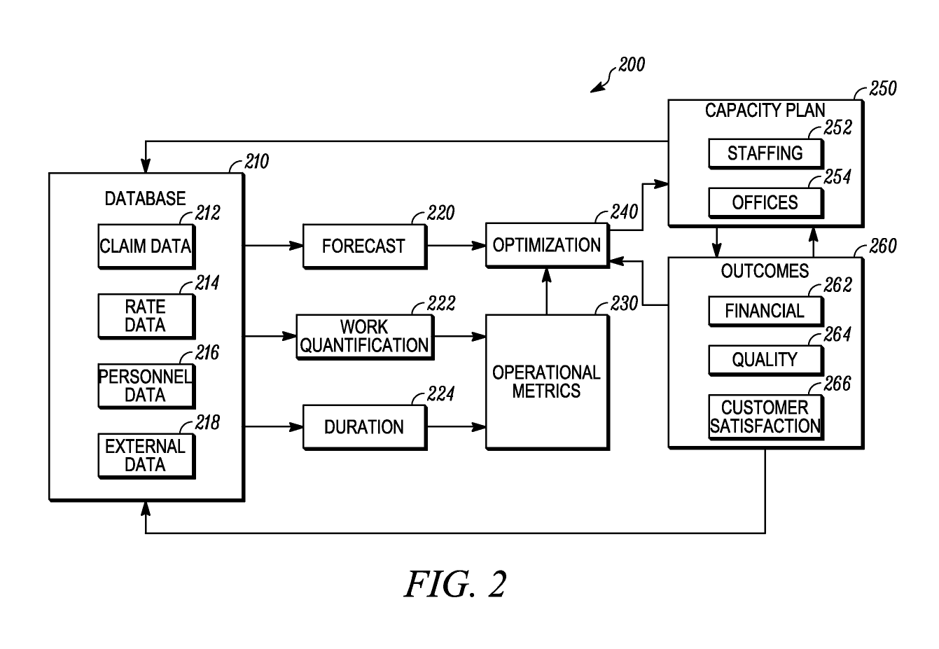

Referring to FIG. 2, a systems-level flow diagram 200 describing the flow of information between the various components of an electronic (e.g., web-based, network-based, or other electronic or optical, wired or wireless, communication-based) system for planning and modeling capacity according to one embodiment of the present invention is shown. The flow diagram 200 describes the transmission and receipt of information for an iterative, feedback-based determination of workload and capacity with respect to business outcomes between a database 210, a forecasting module 220, a work quantification module 222, a claim duration module 224, an operational metric module 230, an optimization module 240, a capacity plan 250, and a set of outcomes 260. Although the flow diagram 200 of FIG. 2 is depicted in an insurance context, the systems and methods of the present invention are not so limited.

The database 210 is used to store claim data 212, rate data 214, personnel data 216, external data 218 and any other data, which may be utilized by the various modules 220, 222, 224, 230, 240 to develop a capacity plan 250 and to analyze the efficacy of the capacity plan 250 with respect to an observed set of outcomes 260. The claim data 212 may include information regarding claims received and handled over periods of time, while the rate data 214 may include information regarding claim premiums and other rates. The personnel data 216 may include information regarding work units or individual claim handlers of various classes, while the external data 218 may include information regarding temporary labor, unemployment rates, average weekly wages, or union membership or qualifications, or any other pertinent data.

The forecasting module 220 shown in FIG. 2 may utilize claim data 212, rate data 214, personnel data 216 and/or external data 218 to forecast a volume of claims expected to be received in a given period of time in the future, and to solve for the level of resources (sometimes called a “resource pool”) that may be required to handle the projected volume of claims. The forecasted volume of claims is based primarily on historical information and may be adjusted according to one or more known factors. Depending on the business of the insurer, claim volumes may be based on, for example, data such as projected unemployment rates (worker's compensation), weather events (property insurance or automobile insurance), life expectancies or medical advancements (life insurance), or any other relevant factors. Additionally, the resource pool that is projected as being required to respond to the forecasted claims may be determined based on planned hiring, estimated losses due to handler turnover or any other factor that may be related to the employment and retention of handlers.

The forecasted claim volumes may be segmented based on any classification, such as claim types and locations (e.g., field offices), periods of consideration (e.g., monthly, quarterly, seasonally, or annually), or in any other manner, and for any line of business, in order to accurately reflect or describe the expected claim volumes with particularity. For example, if a spate of extreme weather is anticipated in a region, a significant increase in the forecasted property and casualty claim volumes for field offices in or around the region may be shown, while smaller increases may be shown in forecasted automobile or worker's compensation claim volumes in or around the region. Likewise, if the unemployment rate is projected to increase or decrease in a particular region, the forecasted worker's compensation claim volumes from that region may be expected to increase or decrease concomitantly, while the forecasted worker's compensation claim volumes from other regions may be expected to either remain constant, or vary for other reasons or based on other factors. By forecasting claim volumes segmented based on claim type, claim location, and/or other criteria, the systems and methods of the present invention may suggest optimal resource requirements for a variety of business scenarios.

The work quantification module 222 shown in FIG. 2 may be used to calculate work-time estimates with respect to work performed based on one or more intrinsic classifications, and to diagnose claim handling operations in a particular office or particular business line.

Presently, work productivity is generally determined by comparing the claim inventory in a particular office or by a particular type of claim at one time against the claim inventory in that office or by that claim type at another time. Such methods, however, fail to consider a worker's overall productivity in the period between the times under consideration, or provide any indication of work that may be shared between the claim handlers in the various offices. For example, by emphasizing the number of open claims instead of the rate at which claims are closed, however, an unproductive office with a large open claim inventory may be falsely viewed as more productive than an office with a small open claim inventory.

The work quantification module 222 calculates a work-time estimate by projecting the total number of hours worked on a particular claim over a unit period of time (e.g., one month), for a particular classification (e.g., claims of a particular type, claims handled by a particular work unit, claims handled by a particular worker). The work quantification module 222 provides improvements over the prior art in that it determines the average time spent handling a claim per month, based on the classification (e.g., claim type, work unit, worker), and/or other classifying factor. Accordingly, once a work-time estimate is determined for claims of a particular classification, the work-time estimate may be reverse-engineered to project case loads of workers or work units under a variety of different business scenarios.

According to one embodiment of the present invention, a work-time estimate may be calculated according to the formula set forth in Equation (1), below:

Σⱼ₌₁^{k}(nⱼxⱼ)ᵢ≈Hᵢ (1)

where nⱼ is the number of claims n of type j; xⱼ is the average number of hours x spent handling claims of type j; k is the total number of claim types; and H is the total number of hours worked. The classification I may represent a type or sub-type of claim (i.e., a claim having an exposure level above a certain threshold), a work unit (i.e., a field office or virtual office handling the claim), a class of workers (i.e., claims handled by a particular level of group manager) or an individual worker.

According to Equation (1), above, work-time may be estimated by reviewing and analyzing assignment histories over a number of respective time periods. Therefore, by focusing on the work that has been completed, rather than on the work that remains open, the systems and methods of the present invention are able to incorporate more specific data into different planning scenarios. Moreover, the work-time estimates may be weighted based on actual experiences, in order to derive expressions of an individual claim service operation's productivity, which may be used to determine desired work-time targets in planning scenarios.

Additionally, work-time estimates may be calculated in accordance with Equation (1) with respect to one or more particular classifications, such as types of claims, field office locations, and/or individual workers or classes of workers. For example, a work-time estimate may be calculated with reference to all claims handled by a single office by adding the time spent on claims in that office and dividing the total time by the number of claims handled by that office in a given month. Once the work-time estimates of each of a series of offices have been calculated, an organization may compare the individual offices to one another, benchmark the offices' productivity relative to specific levels of experience of claim handlers within the office, or create resource scenarios which consider claim handlers with hypothetical work loads using various mixes of claim types. Likewise, a work-time estimate may be calculated for all claims of a particular type by determining the total time spent on claims of that type divided by the number of claims handled of that particular type in a given month. Finally, the work-time estimate may also be calculated with respect to an individual worker, by adding the total time spent on claims by that worker by the number of claims handled by that worker. Such estimates may be considered for the purpose of resource allocation, as well as employee recognition, compensation or promotion.

Therefore, the work-time estimate may be expressed, for example, in the form of a multi-dimensional array reflecting the types of claims and any respective classifications (e.g., individual workers, business lines, offices, and/or regions). For example, where a particular office I employs three workers to handle four types of claims, the work-time estimate of that office may be represented by the array set forth in Equation (2), below:

$${WTE}_{i} = {( \begin{matrix}{x}_{11} & {x}_{12} & {x}_{13} & {x}_{14} \\ {x}_{21} & {x}_{22} & {x}_{23} & {x}_{24} \\ {x}_{31} & {x}_{32} & {x}_{33} & {x}_{34}\end{matrix} )}_{i} \qquad ( 2 )$$

where WTEᵢ is the work-time estimate of office I, and where xⱼₖ represents the individual work-time estimate of worker j with respect to claims of type k.

Moreover, work-time estimates may be calculated based on the status of the claim when it is assigned to a particular worker (i.e., the assignment of a new claim notice versus the assignment of a claim from existing inventory). For example, one work-time estimate may be calculated for a field office with respect to claims considered by that office from the moment that the claim is noticed, while another work-time estimate may be calculated with respect to claims that have been transferred to that office, which require a certain amount of lead time for workers in that office to become acclimated with the facts and circumstances associated with each of the transferred claims. In such a manner, the systems and methods of the present invention may identify field offices that are able to accept other offices' work quickly, and therefore to allocate work to that office. Accordingly, the work-time estimates may be used to adjust for projected increases or decreases in new claim volumes at a field office, as well as increases and decreases in volumes of claims that have been transferred to that field office.

The duration module 224 shown in FIG. 2 may be used to calculate the duration Aᵢ(t) of claims, which is typically expressed in units of time per claim, and may be determined based on claim data 212, including data regarding the notice of a claim, the work expended on that claim, and/or the date on which that claim was closed. Claim durations may be calculated based on any classification, such as the types of claims (e.g., property or automobile claims) or the locations (e.g., the field office where the claim was handled) of the claims.

The number of claims pending in a given time period is generally a function of the number of pending claims in the previous period, plus the number of claims received during the period, less the number of claims closed in the period. Mathematically, this relationship may be expressed according to the claim balance equation set forth in Equation (2), below:

P(t−1)+N(t)=P(t)+C(t) (2)

where P(t−1) is the inventory of claims (i.e., the number of claims for which notices have already been received at time t−1; N(t) is the number of notices received in time period t; C(t) is the number of claims closed in time period t; and P(t) is the inventory of claims at time t.

Accordingly, the claim inventory P(t), or work pending, in a given time period t is generally a function of the new claims for which notices are received during time period t, or N(t), and a portion y of the pending cases for which notices have already been received prior to time period t, or P(t−1). The case load in a given period, expressed in the number of claims per worker L(t), is therefore calculated as set forth in Equation (3), below:

$$L ( t ) = ( \frac{N ( t ) + γ \times P ( t - 1 )}{R ( t )} ) \qquad ( 3 )$$

where L(t) is the case load per representative in time t; and R(t) is the number of claim handlers required in time t.

The duration module 224 estimates throughput using an estimating tool known as a “throughput triangular,” which may be calculated by tracking claim notices received in a fixed, selected period (e.g., one year), and determining when each of the notices is closed with respect to specific intervals (e.g., one month or one quarter) after it is received. According to Little's Law, under steady state conditions, the average number of items in a queuing system equals the average rate at which items arrive, multiplied by the average time that an item spends in the queuing system, as is shown in Equation (4), below:

L=λW (4)

where L is the average number of items entering the queuing system; W is the average time spent in the system by an item; and λ is the average number of items arriving in the queuing system, per unit time.

Therefore, the rate at which the claim notices received within the selected period are closed, by specific interval, may then be projected prospectively to determine when claim notices received in the future will be closed, and retrospectively to determine when outstanding claim notices received in the past will be closed.

For example, if forty-five percent (45%) of claims are closed in the first quarter after their notices have been received; thirty-five percent (35%) of claims are closed in the second quarter after their notices have been received; and twenty (20%) of claims are closed in the third quarter after their notices have been received, then it may be assumed that forty-five percent (45%) of the claims that are noticed in the future will be closed within the first quarter after their notices have been received, thirty-five percent (35%) of the claims will be closed within the second quarter, and twenty percent (20%) of the claims will be closed within the third quarter in the future. Likewise, it may also be assumed that forty-five percent (45%) of the claims for which notices were received in the previous quarter have already been closed; that thirty-five percent (35%) of the claims for which notices were received in the previous quarter will be closed in the current quarter; and that twenty percent (20%) of the claims for which notices were received in the previous quarter will close in the following quarter.

The operational metric module 230 shown in FIG. 2 may be used to determine operational metrics such as the work required to close a claim (“work-to-close a claim”), or Wᵢ(t), which is derived as a function of the work-time estimate and the claim duration, as is shown in Equation (4), below:

W(t)=WTEᵢ(t)×Aᵢ(t) (4)

where Wᵢ(t) is the work-to-close a claim of classification I, typically measured in units of hours per claim; WTEᵢ(t) is the work-time estimate for claims of classification I, typically measured in hours per claim per month; and Aᵢ(t) is the duration of claims of classification I, typically measured in units of months.

According to Equation (4), above, the average time required to close a claim (i.e., the work-to-close a claim, or work closure rate) of any classification may be calculated based on the work-time estimates and the claim duration, which is inversely proportional to the throughput. Calculating an estimate of the work-to-close a claim based on any classification enables an organization to determine the relative productivity of its respective work units (e.g., field offices, business units or individual handlers) by benchmarking work units against one another in terms of efficiency (e.g., comparing one field office to another), and to make more well-informed decisions as to optimization and efficiency. Basing capacity planning and modeling on the work-to-close a claim thus represents a significant improvement over existing methods for determining workload and capacity, which traditionally define office productivity in terms of the number of claims handled by an office in a given month. According to such methods, offices that fail to close claims promptly could be falsely viewed as more productive, because offices having high claim inventories appear to be handling a large number of claims. Conversely, offices that efficiently handle and close claims could be falsely viewed as unproductive, because they maintain lower claim inventories from month-to-month, and therefore appear to be handling fewer claims.

The optimization module 240 shown in FIG. 2 is used to determine optimal outcomes for various business solutions as functions of the work-to-close a claim generated by the operational metric module 230, the forecasts generated by the forecasting module 220, and other external economic indicators. Accordingly, using the optimization module 240, high-level capacity planning may be conducted over a number of periods, and may be optimized to accomplish a designated goal.

The optimization module 240 may consider a number of factors including overall staffing, or the number of representatives R(t); the work-to-close a claim W(t); the duration of a claim A(t); the claim inventory P(t); and the case load L(t), in determining the impacts of various options for accomplishing one or more particular goals.

The optimization module 240 may operate in one or more standard numerical computing environments, such as MATLAB or SAS. The optimization module 40 may be utilized to determine a number of optimal outcomes either in the aggregate, or subject to one or more classifications, and may display the impacts on the various variables under consideration as functions of business decisions. The optimization module may be used to determine outcomes with respect to decisions across an entire business unit (e.g., reducing the total number of claim handlers by five percent) or with respect to discrete aspects of the business unit (e.g., increasing the number of claim handlers in a particular office by ten percent, increasing the case load of a typical class of workers by five percent).

For example, the optimization module 40 may iteratively solve for quadratic solutions to minimize the number of representatives R(t) and the pending claim inventory P(t), as well as the deviations from desired values of the work-to-close a claim W(t) and workload L(t), with respect to the number of representatives R(t) and the work-to-close a claim W(t), and the “work completion ratio,” or the inverse of the duration A(t), subject to any desired restrictions on claim balancing, staffing, or policy. Additionally, the solutions may be derived on a period-by-period basis, on a rolling basis (i.e., considering more than one period at a time), or by considering all of the periods in the aggregate.

The capacity plan 250 shown in FIG. 2 may be generated as a result of the various outputs from the optimization module 240. The capacity plan 250 may include component parts including allocations of staffing 252 and offices 254, and any other relevant aspects or sub-classifications thereof (e.g., staffing of particular classes of workers). The capacity plan 250 may involve increasing or decreasing allocations of staffing 252 and offices 254, or reallocating staffing 252 or offices 254. The capacity plan 250 may also involve increasing or decreasing allocations of claims, or reallocating claims, to other individuals or offices. As is discussed above, the capacity plan 250 may be defined either in the aggregate or subject to one or more classifications. For instance, the optimization module 240 may provide estimates of the staffing in an organization, or may provide more particular staffing estimates relating to individual classes of handlers or the number of handlers at a particular office.

A capacity plan for a particular work unit (e.g., office, group, business line) may be calculated as is shown in Equation (5), below:

$${FTE}_{i} = ( \frac{{N}_{i} ( t ) * {S}_{i} ( t ) + {( {T}_{i} ( t ) + P ( t ) )}_{i} \times {WTE}_{i}}{{H}_{i}} ) \qquad ( 5 )$$

where FTEᵢ is the number of full-time equivalent employees projected to be required at work unit i in time period t; Nᵢ(t) is the forecasted number of new claims to be received at work unit i in time period t; Sᵢ(t) is the amount of time estimated to be required to prepare to receive the new claims at work unit i in time period t; Tᵢ(t) is the forecasted number of claims to be transferred to work unit i in time period t; Pᵢ(t) is the claim inventory at work unit i in time period t; WTEᵢ is the work-time estimate at work unit i in time period t; and Hᵢ is the number of hours worked in work unit i in time period t.

The capacity plan 250 may be developed to be consistent with the defined resource pool and to determine the number of full-time equivalent employees, or representatives R(t), calculated subject to any classification. For example, the capacity plan 250 may be developed for one field office, one product line, or the business at large.

After the capacity plan 250 has been developed and implemented, the claim outcomes 260 shown in FIG. 2 are observed and compared with respect to the capacity plan 250. The claim outcomes may be viewed in multiple contexts, in that no one outcome is driven by any one factor. Primarily, the three factors of interest regarding the claim outcomes 260 include financial considerations 262, quality considerations 264 and customer experiences 266.

As is shown in FIG. 2, information regarding the observed claim outcomes 260 may be returned to the optimization module 240 in the form of feedback. Such information may then be utilized by the optimization module 240 to determine the accuracy of the capacity plan 250 with respect to the observed claim outcomes 260.

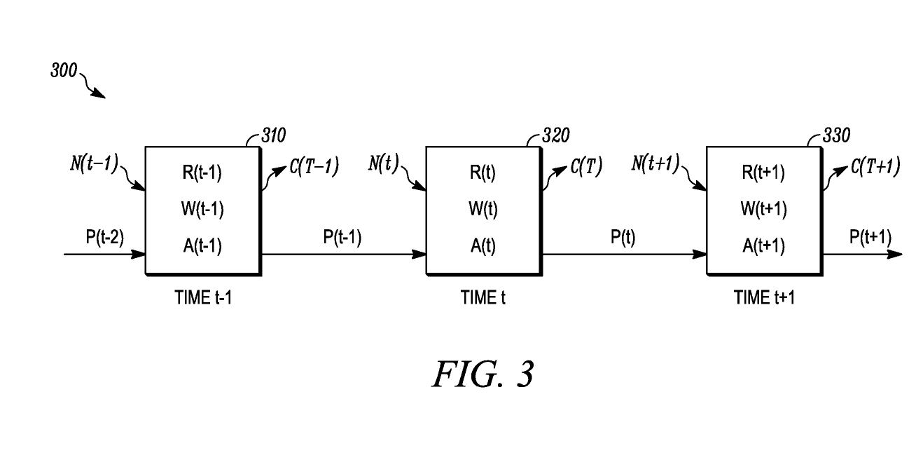

Referring to FIG. 3, a block diagram 300 depicts a claim balance for a system over a number of intervals 310, 320, 330 according to the present invention, as functions of the claim inventory, the number of new claims, the number of closed claims, the number of representatives, the work-to-close a claim, and the claim duration. The block diagram 300 shown in FIG. 3 is consistent with Equation (2), above, and depicts the relationship between new and pending claims, with respect to business-related factors. The block diagram 300 of FIG. 3 may be used to represent the work flow of any type of work unit (e.g., a business line, a field office, and/or an individual, where R=1).

As is shown in FIG. 3, during the respective intervals 310, 320, 330, pending claims P and new claims N are handled by a system having a number of representatives R, a work-to-close a claim value of W, and a claim duration of A. Closed claims C are removed by the system during the interval, and the remaining claims are transferred to the subsequent interval for processing. Accordingly, as is shown in FIG. 3, the productivity of the system during the respective intervals 310, 320, 330 is a function of the staffing (i.e., the number of representatives R) and the productivity (i.e., the work-to-close a claim W and claim duration A) in the system during the respective intervals.

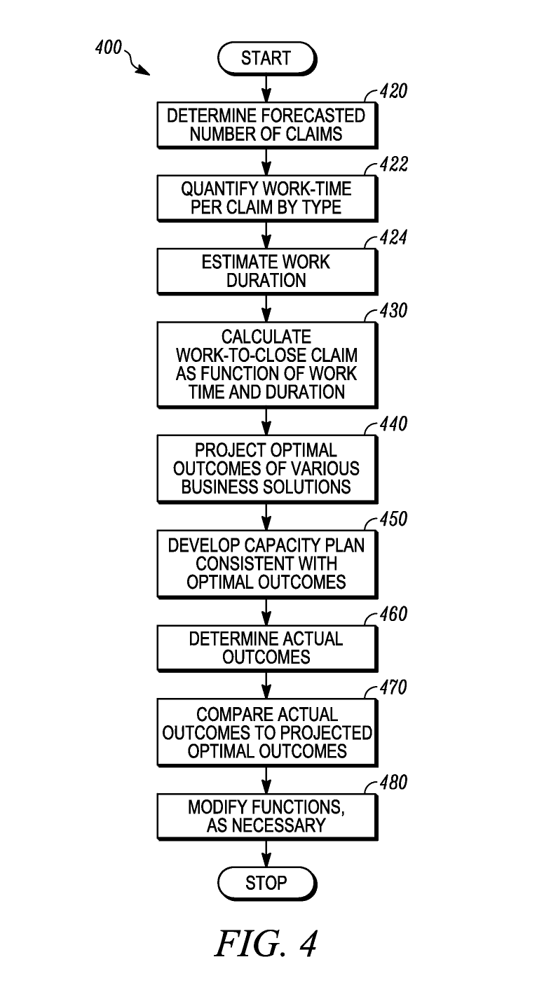

Referring to FIG. 4, a flow chart 400 of a process for planning and modeling workload and capacity according to one embodiment is shown. The process begins at block 420, where forecasts of the projected claim volumes and resource pool are determined. For example, when the systems and methods of the present invention are utilized in a property and casualty insurance context, the forecasted claim volumes may be based on projections of weather forecasts or other property insurance-related factors. When the systems and methods of the present invention are utilized in a worker's compensation insurance context, the forecasted claim volumes may be based on projected unemployment rates, economic indicators, salaries or other factors.

At block 422, the work-time per claim in a given period may be estimated. For example, to quantify work-time for claims handled by a particular field office, the total amount of time spent handling claims by workers in that office in a particular month may be estimated by an equation such as Equations (1) or (2), above.

At block 424, claim duration may be estimated. For example, as is discussed above, a throughput triangular may be developed based on historical data, and used to project the scheduled rate of closure of claims in the future.

At block 430, the work-to-close a claim may be estimated as a function of the work-time estimate and the claim duration, and subject to any classifications (e.g., across the business line, or for a particular type of claim, field office or individual worker). Once the work-to-close a claim has been calculated, then at block 440, the optimization model may determine a set of optimal outcomes of various business solutions as functions of the work-to-close a claim and the forecasted claim notice volume and resource pool.

When one or more business solutions has been chosen, a capacity plan may be developed at block 450 consistent with the associated optimal outcomes. For example, if a set of financial considerations, quality considerations, or level of customer satisfaction is chosen, then a capacity plan to obtain those considerations or that level of customer satisfaction may be implemented. The capacity plan may also be delivered in the form of an output (e.g., a printout, an electronic message) to appropriate personnel.

At block 460, the actual outcomes of claims over a specific period of time may be determined. For example, if the optimal outcomes include financial considerations, regulatory or government considerations, and/or reputation considerations, then the financial, regulatory, and/or reputation impacts associated with the capacity plan may be measured by calculating claim outlays, determining levels of regulatory compliance, and/or monitoring customer comments on social media or networks.

At block 470, the actual claim outcomes may be compared to the projected optimal outcomes determined by the optimization model at block 440. The comparison between the actual claim outcomes and the projected optimal outcomes may also be provided in the form of an output (e.g., a printout, an electronic message) to appropriate personnel. In addition, feedback may be provided to the optimization model at block 480, to further refine the algorithms and/or formulas utilized to develop a capacity plan consistent with optimal outcomes for business solutions in the future. For example, the algorithms or formulas utilized in blocks 440 and 450 may be altered based on the comparison of the actual outcomes to the projected optimal outcomes.

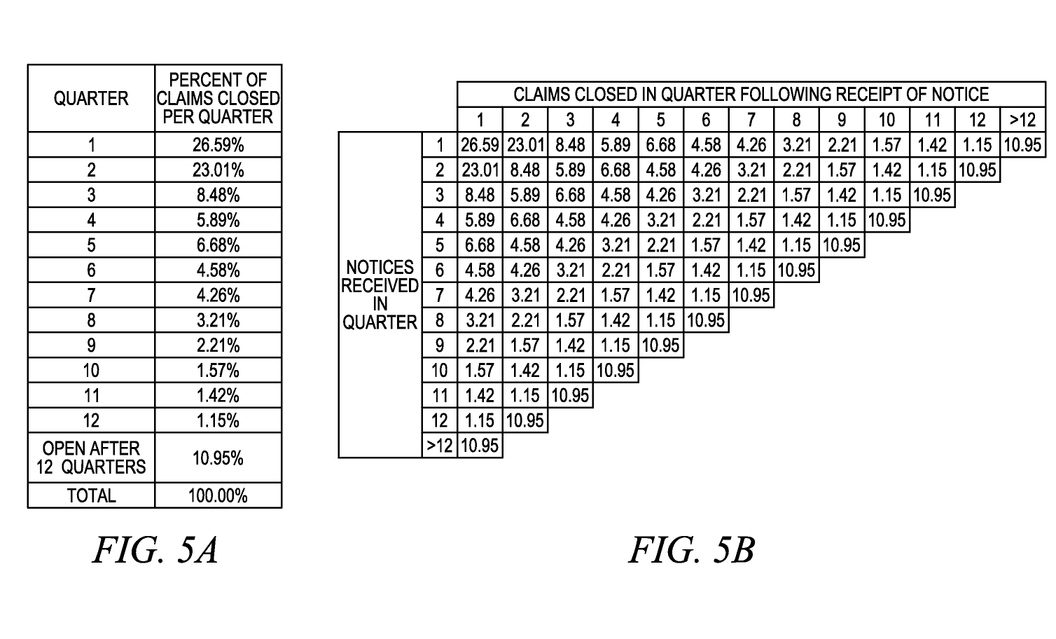

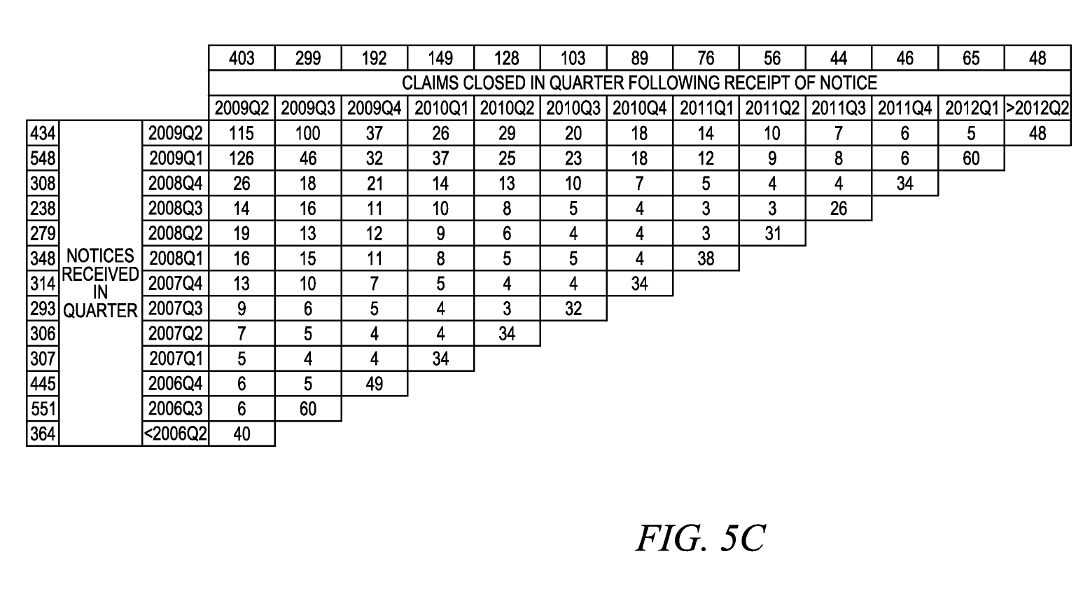

Referring to FIGS. 5A, 5B and 5C, the development of a throughput triangular for a typical projection of claim notice volume is shown. In FIG. 5A, the number of claims closed in a given quarter following the receipt of the claim notices is shown. As is shown in FIG. 5A, on average, 26.59% of the claims are closed in the first quarter after their respective notices are received; 23.01% of the claims are closed in the second quarter; 8.48% of the claims are closed in the third quarter; 5.89% of the claims are closed in the fourth quarter; 6.68% of the claims are closed in the fifth quarter; 4.58% of the claims are closed in the sixth quarter; 4.26% of the claims are closed in the seventh quarter; 3.21% of the claims are closed in the eighth quarter; 2.21% of the claims are closed in the ninth quarter; 1.57% of the claims are closed in the tenth quarter; 1.42% of the claims are closed in the eleventh quarter; 1.15% of the claims are closed in the twelfth quarter; and 10.95% of the claims remain open twelve quarters after their respective notices are received.

In FIG. 5B, the throughput triangular is created by transposing the list of percentages shown in FIG. 5A into a two-dimensional grid reflecting the closure of claims with respect to the quarters in which the claim notices are received. Specifically, the closure rates displayed in FIG. 5A are to be provided both prospectively and retrospectively, and the triangular shown in FIG. 5B may be calculated thereby. For example, as is shown in FIG. 5B, 1.42% of the claims for which notices were received eleven quarters earlier are expected to be closed in the current quarter; 1.15% of the claims are expected to be closed in the next quarter; and 10.95% of the claims are expected to remain open after the next quarter.

Referring to FIG. 5C, the closure rates shown in the triangular of FIG. 5B are applied to claim notices received in previous quarters, and used to project the closure of claims in future quarters. For example, as is shown in FIG. 5C, 238 claim notices were received in the third quarter of 2008 (2008Q3). Of these claims, 14 claims are expected to be closed in the second quarter of 2009 (2009Q2), 16 claims are expected to be closed in the third quarter of 2009 (2009Q3), 11 claims are expected to be closed in the fourth quarter of 2009 (2009Q4), 10 claims are expected to be closed in the first quarter of 2010 (2010Q1), 8 claims are expected to be closed in the second quarter of 2010 (2010Q2), 5 claims are expected to be closed in the third quarter of 2010 (2010Q3), 4 claims are expected to be closed in the fourth quarter of 2010 (2010Q4), 3 claims are expected to be closed in the first quarter of 2011 (2011Q1), 3 claims are expected to be closed in the second quarter of 2011 (2011Q2), and 26 claims—of the original 238 claim notices received in the third quarter of 2008 (2008Q3)—are expected to remain open in the third quarter of 2011 (2011Q3).

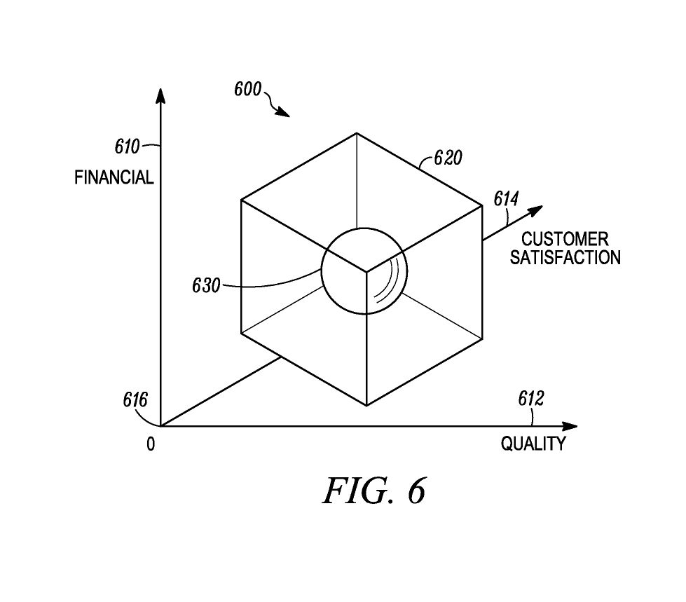

Referring to FIG. 6, a three-dimensional surface plot 600 of outcomes according to one embodiment of the present invention is shown. The plot 600 includes three axes corresponding to outcomes, including financial considerations 610, quality considerations 612, the level of customer satisfaction 614, extending from the origin 616. Additionally, the historical operating space 620, i.e., the region in which the organization typically operates with respect to the three axes, is shown. The optimal outcomes 630 are expressed with respect to the three axes, as a function of optimal financial considerations, quality considerations, and levels of customer satisfaction.

According to systems and methods of the present invention, an optimization model, which may be operated or maintained by the optimization module 240 shown in FIG. 2, is utilized to contract the historical operating space toward the optimal outcomes based on a variety of business solutions. The feedback provided by comparing the projected, optimal outcomes to the actual, observed outcomes may be used to minimize the differentials between the historical operating space and the optimal outcomes by consistently revising and refining the various system components and algorithms used to determine workload and capacity, for example, as are shown in FIG. 2 and in Equations (1)-(5), above.

The systems and methods of the present invention, such as the system 100 shown in FIG. 1, the flow diagram 200 shown in FIG. 2, or the process represented by the flow chart 400 shown in FIG. 4, enable data relating to claims, rates, personnel, and other external factors to be utilized in a more efficient manner in forecasting claim volumes and available resources. The systems and methods of the present invention further permit the respective modules to efficiently interact and communicate with one another. Other arrangements of system components, such as hardware or software, including various additional networked client and server computers and applications operating thereon, may also be used to provide for interactions between and among the various modules of the systems and methods of the present invention.

Those of skill in the pertinent art will recognize that users of the systems and methods of the present invention may utilize a variety of hardware, including a keyboard, a keypads, a mouse, a stylus, a touch screen, a “smart” phone or other device (not shown), or a method for using a browser or other like application, for interacting with the various systems and methods described herein. The computers, servers, and the like described herein have the necessary electronics, software, memory, storage, databases, firmware, logic/state machines, microprocessors, communication links, displays or other visual or audio user interfaces, printing devices, and any other input/output devices to perform the functions described herein and/or achieve the results described herein.

Except where otherwise explicitly or implicitly indicated herein, the terms “insurer,” “insured,” “personnel,” “staff,” “handler” or “third party” may also refer to the associated computer systems operated or controlled by an insurer, an insured, personnel, staff, a handler or a third party, respectively. Furthermore, those of skill in the art will also recognize that process steps described herein as being performed by an “insurer,” “insured,” “personnel,” “staff,” “handler” or “third party” may be automated steps performed by their respective computer systems, and may be implemented within software (e.g., computer programs) executed by one or more client and/or server or other computers.

The protocols and components for providing the respective communications between the databases and modules of the present invention are well known to those skilled in the art of computer communications. As such, they need not be described in more detail herein. Moreover, the data and/or computer executable instructions, programs, firmware, software and the like (also referred to herein as “computer executable components”) described herein may be stored on computer-readable media that is within or accessible by computers or servers and may have sequences of instructions which, when executed by a processor (such as a central processing unit, or CPU), may cause the processor to perform all or a portion of the functions and/or methods described herein. Such computer executable instructions, programs, software and the like may be loaded into the memories of computers or servers, using drive mechanisms associated with a computer readable medium, such as a floppy drive, CD-ROM drive, DVD-ROM drive, network interface, or the like, or via external connections.

The systems and methods of the present invention may be utilized to determine workload and capacity or predict optimal outcomes among various individuals and work units in any industry or in any capacity and at any time. Moreover, the systems and methods of the present invention are not limited to the insurance industry. For example, the systems and methods of the present invention may be utilized to predict optimal outcomes based on workload and forecasted demands at a call center or an airline reservation system, or in connection with any other service industry.

It is to be understood that the embodiments described above are not limited in application to the details of construction and to the arrangements of the components set forth in the above description or illustrated in the drawings. The present invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the scope of the present invention, as defined by the claims.

In addition, features illustrated or described as part of one embodiment can be used in other embodiments to yield a still further embodiment. Additionally, certain features may be interchanged with similar devices or features not mentioned that perform the same or similar functions. It is therefore intended that such modifications and variations are included within the totality of the present invention.

The many features and advantages of the present invention are apparent from the detailed specification, and thus, the appended claims are intended to cover all such features and advantages that fall within the scope of the invention. Further, since numerous modifications and variations will readily occur to those skilled in the art, it is not desired to limit the invention to the exact constructions and operations illustrated and described herein. Accordingly, all suitable modifications and equivalents may be deemed to fall within the scope of the invention.

For example, the specific sequence of the processes described herein may be altered so that certain processes are conducted in parallel or independent with other processes, to the extent that the processes are not dependent upon each other. Thus, the specific order of steps described herein, are not to be considered implying a specific sequence of steps to perform the processes described above. Other alterations or modifications of the above processes are also contemplated, and further insubstantial approximations of the above equations, processes and/or algorithms are also considered within the scope of the processes described herein.

Further, although process steps, algorithms, or the like may be described in a sequential order, and described methods may be depicted (e.g., in one or more flowcharts) as steps connected by directional arrows, such processes may be configured to work in different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

What is claimed is:

1. A computer-based system for optimizing resources, comprising:
a processor; and
a memory in communication with the processor, the memory storing instructions that when executed by the processor result in:
forecasting a projected number of tasks to be completed during a predetermined period;
estimating an amount of work required to complete at least one of the tasks during the predetermined period;
estimating a duration associated with the at least one of the tasks during the predetermined period;
calculating a work closure rate associated with the at least one of the tasks based on the amount of work and the duration;
determining at least one optimal outcome associated with the completion of the projected number of tasks; and
allocating at least one resource to achieve the at least one optimal outcome.

2. The system of claim 1, wherein the instructions, when executed by the processor, further result in:
observing an actual outcome associated with the completion of the projected number of tasks.

3. The system of claim 2, wherein the instructions, when executed by the processor, further result in:
comparing the actual outcome to the at least one optimal outcome.

4. The system of claim 2, wherein determining the at least one optimal outcome is performed using an optimization module.

5. The system of claim 4, wherein the instructions, when executed by the processor, further result in:
providing feedback to the optimization module, the feedback comprising information regarding at least one of the actual outcome and the at least one optimal outcome.

6. The system of claim 4, wherein the optimization module is adapted to iteratively solve for optimal solutions in a numerical computing environment.

7. The system of claim 2, wherein the at least one optimal outcome comprises at least one of an optimal financial metric, an optimal quality metric, an optimal customer satisfaction metric, an optimal regulatory metric, an optimal brand impact, and an optimal reputation metric, and
wherein observing the actual outcome comprises determining at least one of an actual financial metric, an actual quality metric, an actual customer satisfaction metric, an actual regulatory metric, an actual brand impact, and an actual reputation metric.

8. The system of claim 2, wherein the instructions, when executed by the processor, further result in:
storing information regarding the actual outcome in the memory.

9. The system of claim 2, wherein the at least one optimal outcome is determined with respect to at least one discrete aspect of a business unit, and
wherein the actual outcome is observed with respect to the at least one discrete aspect of the business unit.

10. The system of claim 1, wherein allocating the at least one resource comprises implementing a staffing level for a work unit.

11. The system of claim 10, wherein the work unit comprises an office.

12. The system of claim 1, wherein the at least one optimal outcome comprises at least one of an optimal number of representatives, an optimal inventory of the tasks, and an optimal work load.

13. The system of claim 1, wherein each of the tasks comprises an insurance claim.

14. The system of claim 1, wherein the instructions, when executed by the processor, further result in:
developing a capacity plan based on the at least one optimal outcome.

15. The system of claim 14, wherein the capacity plan comprises a staffing level.

16. A computer-based method for identifying optimal resources, the method comprising:
calculating, by a processing device, a quantity of work associated with the completion of at least one of a class of tasks;
forecasting, by the processing device, a number of tasks in the class for a predetermined period;
determining, by the processing device, at least one optimal outcome based on the quantity of work and the forecasted number of tasks; and
observing, by the processing device, an actual outcome following the completion of a number of tasks in the class for the predetermined period.

17. The method of claim 16, further comprising comparing, by the processing device, the actual outcome to the at least one optimal outcome.

18. The method of claim 16, wherein determining the at least one optimal outcome is performed using an optimization module, and further comprising:
providing, by the processing device, feedback to the optimization module, the feedback comprising information regarding at least one of the actual outcome and the at least one optimal outcome.

19. The method of claim 18, wherein the optimization module is adapted to iteratively solve for optimal solutions in a numerical computing environment.

20. The method of claim 16, wherein calculating the quantity of work comprises:
determining, by the processing device, an amount of time required to complete the at least one of the class of tasks, and
determining, by the processing device, a duration of the at least one of the class of tasks,
wherein the quantity of work is proportional to a product of the amount of time and the duration.

21. The method of claim 16, further comprising developing, by the processing device, a capacity plan based on the at least one optimal outcome.

22. The method of claim 21, wherein the capacity plan comprises a staffing level.

23. The method of claim 16, wherein each class of tasks comprises a type of insurance claim.

24. The method of claim 16, wherein the at least one optimal outcome comprises at least one of an optimal financial metric, an optimal quality metric, an optimal customer satisfaction metric, an optimal regulatory metric, an optimal brand impact, and an optimal reputation metric, and
wherein observing the actual outcome comprises determining at least one of an actual financial metric, an actual quality metric, an actual customer satisfaction metric, an actual regulatory metric, an actual brand impact, and an actual reputation metric.

25. The method of claim 16, further comprising storing, by the processing device, information regarding the actual outcome.

26. The method of claim 16, wherein the optimal outcome comprises at least one of an optimal number of representatives, an optimal inventory of the tasks, and an optimal work load.

27. The method of claim 16, wherein the at least one optimal outcome is determined with respect to at least one discrete aspect of a business unit, and wherein the actual outcome is observed with respect to the at least one discrete aspect of the business unit.
